(19) United States
(12) Patent Application Publication
(10) Pub. No.: US 2007/0089316 A1
(43) Pub. Date: Apr. 26, 2007

(54) Clothing drying machine

(75) Inventors: Jin Doo Kim, Suwon-Si (KR); Kyu Chai Lee, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/481,068

(22) Filed: Jul. 6, 2006

(30) Foreign Application Priority Data
Oct. 20, 2005 (KR) 2005-99121

(51) Int. Cl. F26B 21/06

(52) U.S. Cl. 34/82

(57) ABSTRACT

A clothing drying machine having a subsidiary rack detachably installed in a drying tub. The clothing drying machine includes a cylindrical drying tub, the front and rear surfaces of which are opened; a front support plate rotatably supporting the opened front surface of the drying tub; and a subsidiary rack detachably installed in the drying tub for supporting laundry, and provided with a front support portion, the front end of which is supported by the front support plate, wherein through holes for passing air are formed through the front support portion, thereby preventing the reduction in the flow speed of the air due to the subsidiary rack.

### CROSS-REFERENCE TO RELATED APPLICATIONS

This application claims the benefit of Korean Patent Application No. 2005-0099121, filed Oct. 20, 2005, in the Korean Intellectual Property Office, the disclosure of which is incorporated herein by reference.

### BACKGROUND OF THE INVENTION

1. Field of the Invention

The present invention relates to a clothing drying machine, and more particularly, to a clothing drying machine having a subsidiary rack detachably installed in a drying tub.

2. Description of the Related Art

Generally, clothing drying machines dry laundry by rotating a drying tub containing wet laundry at a low speed and allowing air of a high temperature to flow into the drying tub.

A conventional clothing drying machine includes a housing defining the external appearance of the drying machine, a drying tub rotatably installed in the housing and having a cylindrical structure, front and rear surfaces of which are opened for containing laundry therein, a driving device for rotating the drying tub, an air blowing device for blowing air to the inside of the rotating drying tub, a suction channel for guiding the air to the inside of the drying tub, and a discharge channel for guiding the air to the outside of the drying tub. The air passes through the drying tub through the suction channel and the discharge channel, thereby drying the laundry in the drying tub.

Front and rear support plates for rotatably supporting front and rear ends of the drying tub are provided at front and rear portions of the drying tub. The suction channel is connected to the upper portion of the rear support plate, and the discharge channel is connected to the upper portion of the front support plate. A filter member for filtering the air discharged through the discharge channel to remove foreign substances from the air is installed in the front support plate, to which the discharge channel is connected, and a discharge hole for allowing the filtered air to be supplied to the discharge channel is formed through the filter member.

Since the laundry is dried by the repetitions of the lifting and dropping of the laundry through the rotation of the drying tub, when the laundry includes heavy and hard sports shoes, the above clothing drying machine generates noise due to impact caused by the dropping of the laundry, and damages the laundry. Accordingly, Japanese Laid-open Patent Publication No. 2001-17797 discloses a clothing drying machine having a subsidiary rack, which maintains its horizontal state and is fixedly installed in a drying tub to support laundry, such as sports shoes, in a fixed state so that the laundry can be easily dried.

However, since a front end of the subsidiary rack of the above conventional clothing drying machine is disposed above a discharge hole, flow resistance to air sucked into the discharge hole is generated by the subsidiary rack. Thus, the flow speed of the air is reduced, thereby deteriorating the drying efficiency of the clothing drying machine.

### SUMMARY OF THE INVENTION

Therefore, one aspect of the invention is to provide a clothing drying machine which has a subsidiary rack detachably installed in a drying tub so as to decrease the reduction in the speed of air flow.

In accordance with one aspect, the present invention provides a clothing drying machine including: a cylindrical drying tub, the front and rear surfaces of which are opened; a front support plate rotatably supporting the opened front surface of the drying tub; and a subsidiary rack detachably installed in the drying tub for supporting laundry, and provided with a front support portion, the front end of which is supported by the front support plate, wherein through holes for passing air are formed through the front support portion.

Discharge holes for passing the air discharged from the drying tub may be formed through the front support plate so that the front support portion is disposed above the discharge holes, and the through holes may be correspondingly located above the discharge holes.

The front support plate may include a filter member detachably installed on the front support plate for removing foreign substances from the air discharged from the drying tub, and having the discharge holes formed through the upper surface thereof.

A hand grip for easily handling the filter member may be formed on the central portion of the upper surface of the filter member, the discharge holes may be provided at both sides of the hand grip, and the through holes may be provided at both sides of the front support portion corresponding to the discharge holes.

The clothing drying machine may further include a filter case, the upper end of which passes through the lower portion of the front support plate and is protruded towards the inside of the front support plate, and, through which a filter installation hole for detachably installing the filter member in the filter case therethrough is formed.

A circular opening for inserting laundry into the drying tub may be formed through the front support plate, the upper surfaces of the filter case and the filter member may have a concave arc shape corresponding to the opening, and the front support portion may have a convex arc shape corresponding to the upper surface of the filter case and is mounted on the upper surface of the filter case.

In accordance with another aspect, the present invention provides a clothing drying machine including: a cylindrical drying tub, the front and rear surfaces of which are opened; front and rear support plates rotatably supporting the opened front and rear surfaces of the drying tub respectively; a subsidiary rack detachably installed in the drying tub for supporting laundry and provided with front and rear ends respectively supported by the front and rear support plates; discharge holes for passing air to be discharged from the drying tub; and through holes formed through the subsidiary rack above the discharge holes so that air passed through the through holes can flow towards the discharge holes.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a perspective view illustrating the configuration of a clothing drying machine in accordance with the present invention;

FIG. 2 is a perspective view illustrating the detachable structure of a subsidiary rack of the clothing drying machine in accordance with the present invention; and

FIG. 3 is an enlarged view of the portion “III” of FIG. 1.

### DETAILED DESCRIPTION OF THE PREFERRED EMBODIMENTS

Reference will now be made in detail to the embodiment of the present invention, an example of which is illustrated in the accompanying drawings, wherein like reference numerals refer to like elements throughout. The embodiment is described below to explain the present invention by referring to the annexed drawings.

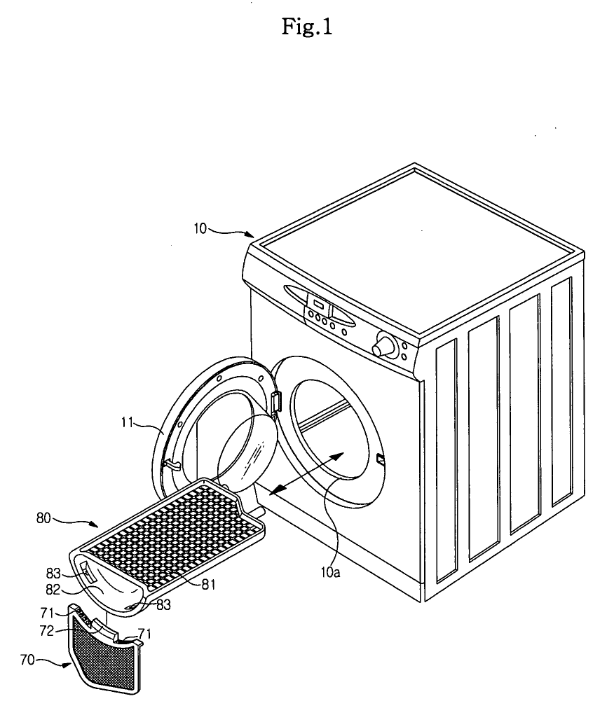

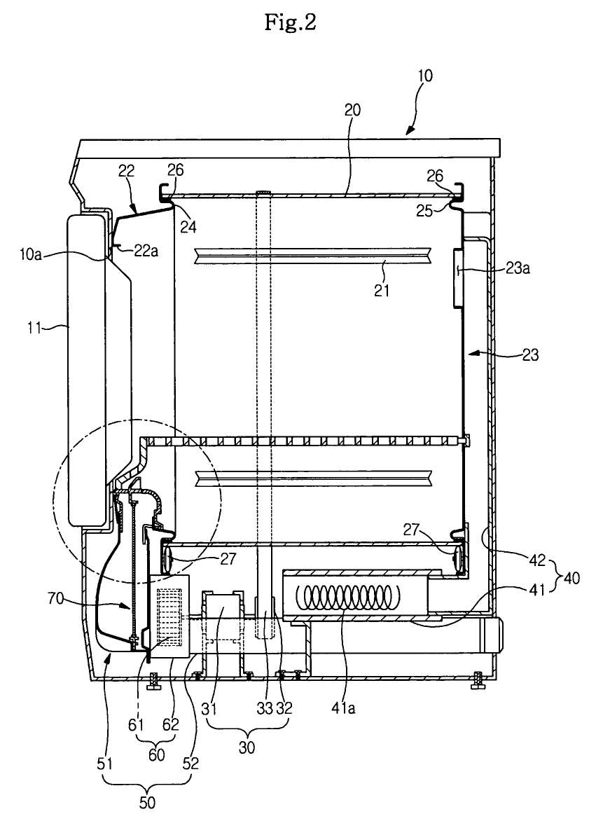

As shown in FIGS. 1 and 2, a clothing drying machine in accordance with the present invention includes a housing 10 defining the external appearance of the drying machine, a drying tub 20 rotatably installed in the housing 10, a driving device 30 for rotating the drying tub 20, a suction channel 40 for guiding the air to the inside of the drying tub 20, a discharge channel 50 for guiding the air to the outside of the drying tub 20, and an air blowing device 60 for circulating the air to the inside of the drying tub 20 through the suction channel 40 and the discharge channel 50,

The drying tub 20 has a cylindrical structure, front and rear surfaces of which are opened, and a plurality of lifters 21 for lifting laundry are installed on the inner circumferential surface of the drying tub 20. Front and rear support plates 22 and 23 are fixedly installed at front and rear ends of the drying tub 20 in the housing 10 such that the front and rear support plates 22 and 23 cover the opened front and rear surfaces of the drying tub 20 and rotatably support the opened front and rear surfaces of the drying tub 20.

Front and rear support protrusions 24 and 25 are respectively formed on the front and rear support plates 22 and 23. The front and rear support protrusions 24 and 25 are inserted into the front and rear ends of the drying tub 20 so that the front and rear support protrusions 24 and 25 rotatably support the front and rear ends of the drying tub 20. Antifriction members 26 for minimizing frictional resistance are respectively interposed between the front end of the drying tub 20 and the front support protrusion 24 and between the rear end of the drying tub 20 and the rear support protrusion 25. Rollers 27 for rotatably supporting the drying tub 20 are respectively installed on the lower portions of the front and rear support plates 22 and 23.

Circular openings 10a and 22a for inserting and taking laundry into and out of the drying tub 20 therethrough are respectively formed through the front surface of the housing 10 and the front support plate 22, and a door 11 for opening and closing the openings 10a and 22a is installed on the front surface of the housing 10.

The driving device 30 for rotating the drying tub 20 includes a driving motor 31 installed in the lower portion of the housing 10, and a pulley 32 and a belt 33 for transmitting the driving force of the driving device 31 to the drying tub 20. The belt 33 is wound on the outer circumferential surface of the pulley 32 connected to one end of a rotary shaft of the driving motor 31 and the outer circumferential surface of the drying tub 20, thereby allowing the drying tub 20 to be rotated by the rotation of the driving motor 31.

The suction channel 40 includes a lower suction duct 41 installed below the drying tub 20 in the housing 10, and a rear suction duct 42 installed in the rear of the rear support plate 23 for connecting the lower suction duct 41 to a suction hole 23a formed through the upper portion of the rear support plate 23. A heater 41a for heating sucked air is installed in the lower suction duct 41.

The discharge channel 50 includes a filter case 51, an upper end of which passes through the lower portion of the front support plate 22 and is protruded towards the inside of the lower portion of the front support plate 22, and, on which a filter member 70 for removing foreign substances from air discharged from the drying tub 20 is detachably installed, an air blowing case 62 connected to the lower portion of the filter case 51 and having an air blast fan 61 installed therein and rotated for generating suction force and air blowing force, and a discharge duct 52 connected to the rear surface of the air blowing case 62 for guiding the air to the rear portion of the housing 10 so that the air is discharged to the outside of the clothing drying machine.

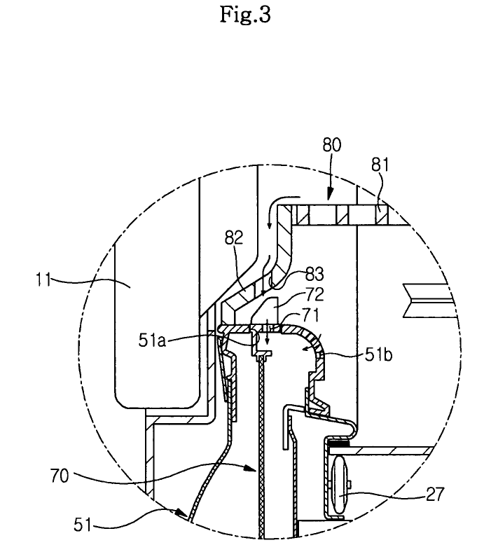

As shown in FIG. 3, a filter installation hole 51a is formed through the upper surface of the filter case 51 so that the filter member 70 is detachably installed on the filter case 51 through the filter installation hole 51a, and discharge holes 71 and 51b are respectively formed through the upper surface of the filter member 70 and the rear surface of the filter case 51 so that air to be filtered by the filter member 70 is introduced into the filter case 51 through the discharge holes 71 and 51b. In this embodiment, the upper surfaces of the filter member 70 and the filter case 51 have a concave arc shape corresponding to the circular openings 10a and 22a.

With reference to FIG. 1, the air blowing device 60 includes the air blast fan 61 provided with the pulley 32 at one end thereof and installed at the other end of the rotary shaft of the driving motor 31 for rotating the drying tub 20, and the air blowing case 62 surrounding the air blast fan 61 and connected to the filter case 51 and the discharge duct 52.

Accordingly, when the drying tub 20 and the air blowing fan 61 are rotated by the driving motor 31, the laundry in the drying tub 20 is lifted and then dropped, and air is circulated into the drying tub 20 through the suction channel 40 and the discharge channel 50 by the air blast fan 61, thereby drying the laundry. Further, the heater 41a, which is disposed in the lower suction duct 41, heats the air supplied to the drying tub 20 to a high temperature, thereby more rapidly drying the laundry in the drying tub 20.

In order to fixedly dispose heavy and hard laundry, such as sports shoes, in the drying tub 20 of the clothing drying machine so that the laundry can be dried, a subsidiary rack 80 is detachably installed in the drying tub 20.

Front and rear ends of the subsidiary rack 80 are longitudinally extended so that the front and rear ends of the subsidiary rack 80 can be respectively supported by the front and rear support plates 22 and 23. Thereby, the subsidiary rack 80 has a designated length and a designated width such that laundry can be laid on the subsidiary rack 80. The subsidiary rack 80 includes a grid portion 81 for allowing the air passing through the drying tub 20 or the water of the laundry to flow to the lower portion of the drying tub 20, and a front support portion 82 having a convex arc shape corresponding to the upper surfaces of the filter member 70 and the filter case 51, installed on the front end of the subsidiary rack 80 and supported by the upper surface of the filter case 51.

When the front support portion 82 of the subsidiary rack 80 is supported by the upper surface of the filter case 51 as shown in FIG. 3, the front support portion 82 is disposed above the discharge holes 71 formed through the upper surface of the filter member 70, thereby increasing a probability of increasing resistance to air flow introduced into the discharge holes 71 of the filter member 70 by the front support portion 82 of the subsidiary rack 80.

Accordingly, in order to reduce the increase of the resistance to air flow due to the subsidiary rack 80, through holes 83 for passing air and allowing the air to flow towards the discharge holes 71 of the filter member 70 are formed through the front support portion 82 of the subsidiary rack 80.

In order to allow the air to smoothly flow towards the discharge holes 71 of the filter member 70, the through holes 83 are located just above the discharge holes 71 of the filter member 70. In this embodiment, a hand grip 72 is extended upwardly from the central portion of the upper surface of the filter member 70 so that a user can easily hold the hand grip 72 to attach and detach the filter member 70 to and from the filter case 51. Since the discharge holes 71 of the filter member 70 are provided at both sides of the hand grip 72 formed on the upper surface of the filter member 70, the through holes 83 are provided at both sides of the front support portion 82 corresponding to the discharge holes 71 of the filter member 70.

Accordingly, since air is sucked into the discharge holes 71 formed through the upper surface of the filter member 70 through the through holes 83 located at positions corresponding to the discharge holes 71, the increase of flow resistance generated due to the subsidiary rack 80 is drastically reduced.

As apparent from the above description, the present invention provides a clothing drying machine, in which through holes for passing air are formed through a front support portion of a subsidiary rack disposed above discharge holes so that the air flows towards the discharge holes, thus preventing the reduction in flow speed of the air due to the subsidiary rack and the reduction in drying efficiency caused thereby.

Although an embodiment of the invention has been shown and described, it would be appreciated by those skilled in the art that changes may be made in this embodiment without departing from the principles and spirit of the invention, the scope of which is defined in the claims and their equivalents.

What is claimed is:

1. A clothing drying machine comprising:
a cylindrical drying tub, the front and rear surfaces of which are opened;
a front support plate rotatably supporting the opened front surface of the drying tub; and
a subsidiary rack detachably installed in the drying tub for supporting laundry, and provided with a front support portion, the front end of which is supported by the front support plate,
wherein through holes for passing air are formed through the front support portion.

2. The clothing drying machine as set forth in claim 1, wherein discharge holes for passing the air discharged from the drying tub are formed through the front support plate so that the front support portion is disposed above the discharge holes, and the through holes are correspondingly located above the discharge holes.

3. The clothing drying machine as set forth in claim 2, wherein the front support plate comprises a filter member detachably installed on the front support plate for removing foreign substances from the air discharged from the drying tub, and having the discharge holes formed through the upper surface thereof.

4. The clothing drying machine as set forth in claim 3, wherein a hand grip for easily handling the filter member is formed on the central portion of the upper surface of the filter member, the discharge holes are provided at both sides of the hand grip, and the through holes are provided at both sides of the front support portion corresponding to the discharge holes.

5. The clothing drying machine as set forth in claim 3, further comprising a filter case, the upper end of which passes through the lower portion of the front support plate and is protruded towards the inside of the front support plate, and, through which a filter installation hole for detachably installing the filter member in the filter case therethrough is formed.

6. The clothing drying machine as set forth in claim 5, wherein a circular opening for inserting laundry into the drying tub is formed through the front support plate, the upper surfaces of the filter case and the filter member have a concave arc shape corresponding to the opening, and the front support portion has a convex arc shape corresponding to the upper surface of the filter case and is mounted on the upper surface of the filter case.

7. A clothing drying machine comprising:
a cylindrical drying tub, the front and rear surfaces of which are opened;
front and rear support plates rotatably supporting the opened front and rear surfaces of the drying tub respectively;
a subsidiary rack detachably installed in the drying tub for supporting laundry and provided with front and rear ends respectively supported by the front and rear support plates;
discharge holes for passing air to be discharged from the drying tub; and
through holes formed through the subsidiary rack above the discharge holes so that air passed through the through holes can flow towards the discharge holes.

8. The clothing drying machine as set forth in claim 7, wherein the discharge holes are formed through the front support plate, and the through holes are formed through the front portion of the subsidiary rack so that the through holes correspond to the discharge holes.

9. The clothing drying machine as set forth in claim 8, wherein the front support plate comprises a filter member detachably installed on the front support plate for removing foreign substances from the air discharged from the drying tub, and having the discharge holes formed through the upper surface thereof.

10. The clothing drying machine as set forth in claim 9, wherein a hand grip for easily handling the filter member is formed on the central portion of the upper surface of the filter member, the discharge holes are provided at both sides of the hand grip, and the through holes are provided at both sides of the front support portion corresponding to the discharge holes.

11. The clothing drying machine as set forth in claim 9, further comprising a filter case, the upper end of which passes through the lower portion of the front support plate and is protruded towards the inside of the front support plate, and, through which a filter installation hole for detachably installing the filter member in the filter case therethrough is formed.

12. The clothing drying machine as set forth in claim 11, wherein a circular opening for inserting laundry into the drying tub is formed through the front support plate, the upper surfaces of the filter case and the filter member have a concave arc shape corresponding to the opening, a front support portion having a convex arc shape corresponding to the upper surface of the filter case and mounted on the upper surface of the filter case is formed on the front end of the subsidiary rack, and the through holes are formed through the front support portion.
